(19) United States
(12) Patent Application Publication
(10) Pub. No.: US 2009/0313102 A1
(43) Pub. Date: Dec. 17, 2009

(54) PEER TO PEER SOCIAL NETWORKING

(75) Inventors: Bertrand C. Le Roy, Bellevue, WA (US); Andres Sanabria, Sammamish, WA (US); Simon Calvert, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/139,342

(22) Filed: Jun. 13, 2008

(51) Int. Cl. G06Q 30/00; G06F 15/16; G06F 7/10; G06F 17/30

(52) U.S. Cl. 705/14.25; 709/203; 707/4; 707/E17.111; 707/E17.047

(57) ABSTRACT

Accessing data through a social network. User input may be received at a node in a social network requesting access to data or requesting a search for data. The node includes data for an entity. In some embodiments, the entity controls the data at the node exclusive of centralized control of the social network. The node further comprises one or more references defining relationships to other nodes. The relationships are defined on an informational basis such that information in data at one node is related through a relationship to information in data at another node. Each of the other nodes includes other data about other entities. Embodiments may further include receiving data at the node from one or more of the other nodes based on one or more of the relationships. At the node, the data from the other nodes may be published.

### BACKGROUND

### Background and Relevant Art

Social networks allow for linking entities to one another through various relationships. For example, some social networks allow a first entity to be linked to other entities where the other entities have a friendship relationship with the first entity. Other social networks include relationships based on business interactions. For example, a social network may link entities by virtue of their coworker status, manager/subordinate status, business partner status etc

Typically, social networks are implemented under the control of a central authority that ultimately controls information about the entities on the social network. For example, the central authority may maintain a server, where the server includes a plurality of nodes. Each node corresponds to an entity for which data is maintained on the social network. The nodes can be interconnected by the relationships. By virtue of the fact that the central authority controls the web server on which each of the nodes has implemented, the central authority can delete data from the nodes, delete relationships between nodes, or completely delete a node from the server.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Some embodiments are directed to accessing data through a social network. For example, user input may be received at a node in a social network requesting access to data or requesting a search for data. The node includes data for an entity. In some embodiments, the entity controls the data at the node exclusive of centralized control of the social network. The node further comprises one or more references defining relationships to other nodes. The relationships are defined on an informational basis such that information in data at one node is related through a relationship to information in data at another node. Each of the other nodes includes other data about other entities. In some embodiments, the data at one or more of the other nodes is controlled by each their respective entity exclusive of centralized control of the social network. Embodiments may further include receiving data at the node from one or more of the other nodes based on one or more of the relationships. Data may also be received based on the user input, or automatically. At the node, the data from the other nodes may be published. Publishing may include, for example, one or more of displaying the data or forwarding the data to another display point.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a social network topology where nodes are implemented at separate servers;

FIG. 2 illustrates a method of publishing data on a social network; and

FIG. 3 illustrates a method of searching on a social network.

### DETAILED DESCRIPTION

Social networking relates to networks of individuals and organizations (sometimes referred to herein as entities) represented by computer implemented nodes that are connected by relations. In some embodiments described herein, a fully-distributed social network is implemented where each node owns its data exclusive of control by a central authority. Instead of storing all the data for all nodes on a central site, a peer to peer social network is built by establishing direct relations between nodes, which may be on distinct servers. Thus, no central authority has the ability to delete data from a node.

In this model, each node is the only owner of its data. There is no lock-in as there is no central entity. The subsistence of the network is ensured by its distributed nature. In particular, removing a node does not break the whole network. Evolution and innovation can happen anywhere on the network and can be propagated.

Some embodiments alternatively and/or additionally include innovative searching based on the relationships in a social network. Typically, information is stored on the Internet in a fundamentally distributed fashion. However searching of that information is centralized to big search engines. Because of this, relevance based on inclusion in a social network may be lost. However, some embodiments described herein use social networks to enable a search model where the information is rated and searched in a distributed and contextual way based on relationships between nodes in the social network. A search could begin on a specific web site that focuses on the topic for which the user wants information. The search could be propagated by crawling the social network from node to node through relationships at search time. The information that will be found may be more relevant by virtue of the relationships.

Additionally, social networks can be refined into sub-networks through the use of tagging. Tagging may include associating keywords or topics with information. Tagging can be used to filter the contents of a node or network in the context of a search or of direct browsing and information sharing.

Information sharing and spreading through such a social network, in some embodiments can be encouraged by a revenue sharing model where content is licensed to be copied or referenced with embedded ads that would benefit the original contents author and optionally the nodes that relayed it.

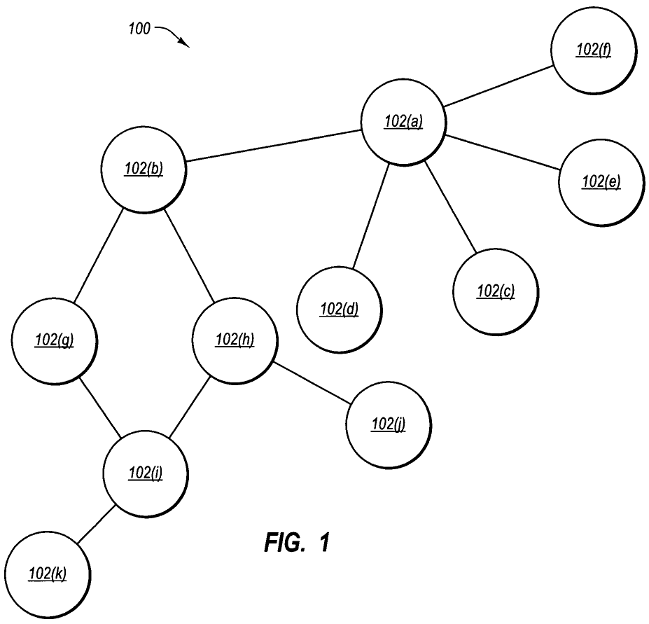

Referring now to FIG. 1, a topology where embodiments may be practiced is illustrated. It should be noted at this point that references to designators in the Figures may be made generically or specifically when the Figures include more than one instance of an item illustrated. For example, a generic reference may include a reference to nodes 102 generically while a reference to a specific node may include an additional designator appended to a reference such as is illustrated in FIG. 1 where the specific references to nodes 102 include additional designators such that the specific references may be one or more of 102(a)-102(k).

FIG. 1 illustrates a first social network topology 100. The first topology 100 includes a number of nodes including nodes 102(a)-102(k). In the topology 100, each of the nodes 102 includes information for a separate entity and is implemented where the entity has control of the data for the entity, exclusive of a central entity for the social network. For example, each of the nodes 102 may be implemented on a separate server under the control of each their own entity. Nonetheless, a social network may be created by connecting nodes 102 by establishing relationships between entities corresponding to the nodes 102. It should be noted that embodiments may include some nodes that are under control of a central authority. Thus, recitations of control of nodes being exclusive of a central authority do not require that all nodes in the social network be excluded from the control of a central authority. Some embodiments may be implemented where some nodes are under the control of a central authority and some exclude control of a central authority over data at the nodes. Other embodiments may be implemented where all nodes exclude control of a central authority over data at the nodes.

In FIG. 1, the node 102(a) is shown as having a first-degree connection with nodes 102(b), 102(c), 102(d), 102(e), and 102(f). This connection represents a first-degree relationship between an entity controlling data at node 102(a) and corresponding entities controlling data at nodes 102(b), 102(c), 102(d), 102(e), and 102(f). Similarly, and entity controlling data at node 102(b) has a first degree relationship with entities controlling nodes 102(a), 102(g) and 102(h). As such, the entity controlling data at node 102(a) has a second-degree relationship with entities controlling nodes 102(g) and 102(h). Further, the entity controlling node 102(b), in addition to having a first-degree relationship with the entity controlling node 102(h), also has a third-degree relationship with the entity controlling node 102(h) through the first-degree relationship with the entity controlling node 102(g) and the second-degree relationship with the entity controlling node 102(i). While not enumerated here, other degrees of relationships can be determined by the reader by inspection.

To facilitate establishing a social network, some embodiments include a set of data formats and protocols that enable a peer to peer server network to be built. In particular, if the nodes 102(a) through 102(f) are implemented on each their own server, data formats and protocols can be used to enable the network illustrated in the social network topology 100 to be formed and maintained.

The network represented by the social network topology 100 may be built by specifying the first-degree relationships at each node 102 or site. These relations can optionally be rated positively or negatively to quantify the confidence a node 102 attributes to them. For example, node 102(a) may maintain ratings for the relationships to nodes 102(b) through 102(f). The rating may define a degree of trust assigned to a relationship. The degree of trust may include factors such as relevance, presumed accuracy, shared or similar interest or taste, or other factors.

Additionally or alternatively, the relationships and can optionally be tagged with a set of keywords, where the keywords can also be rated. For example, an entity at node 102(a) can establish a friendship relationship with an entity at node 102(b). The entity corresponding to node 102(a) may share similar tastes in music with the entity corresponding to the node 102(b), but may distrust the entity's taste in movie selections. Thus, a relationship between the entity corresponding to node 102(a) and the entity corresponding to node 102(b) may be tagged by the entity corresponding to node 102(a) with the keywords music and movies, where the keyword music is given a high or positive rating and the keyword movies is given a low or negative rating. Notably, ratings may be assigned in a number of different ways, including but not limited to, by an absolute positive or negative rating, by a relative rating showing a degree of trust (e.g. 1 to 5 stars), or in other appropriate ways.

In one embodiment, when the administrator of one node 102 publishes shared information, the node pushes the data and optionally associated ratings and tags to all first-degree relationships that have been identified by the administrator. The administrators of the relationship nodes 102 are then free to publish that received information or to reject it. These decisions may be based in some embodiments, either automatically or manually, on the various ratings discussed above. The shared information can be further propagated to other nodes. Additionally or alternatively, as with decisions about whether or not to publish information, decisions about whether or not to propagate the shared information can be based on the various ratings. Publishing may include, for example, one or more of displaying the data or forwarding the data to another display point such as another node.

In some alternative embodiments, a target node 102 queries all its first degree relationships for new data. This may be performed at the request of a user accessing the target node 102. Additionally or alternatively, this may be performed by the administrator of the node 102 desiring to publish information from other nodes, and thus initiating the search. Alternatively or additionally, this may be performed automatically without direct user intervention at the time of the search due to administrator settings set previously. The query embodiments enable the queried nodes to additionally query their own first degree relationships. The social network can in this way be crawled for information. In these embodiments, the query associated with the address of the node 102 where it originated is propagated through the social network from node 102 to node 102 based on entity relationships. Each node's response can travel back through each node according to the entity relationships or each target node can send back information directly to the originating node.

Search requests and results may be propagated or evaluated based on relationship and/or relationship tag ratings described above. For example, searches may not be propagated to nodes where the relationship or a tag for the relationship is rated negatively. Illustratively, if a search is directed to movies, and the tag for movies for a relationship has a negative rating, the search may not be propagated from the node 102 that has a negative tag rating for movies to the node 102 for which the negative tag rating applies.

Illustrating now an example, assume that a user at node 102(a) requests that a search be performed to find information about movies. A request can be propagated to the node's (102(a)) first-degree connections, nodes 102(b)-102(f). These nodes may return any relevant results that they have and further propagate the request to their first-degree connections. For example, at node 102(b), the request may be propagated to nodes 102(g) and 102(h). Node 102(g) may propagate the request to node 102(i), which propagates the request to node 102(k) and 102(h). Node 102(h) may propagate the request to node 102(j).

As noted, results may be returned via node connections or directly. For example, node 102(k) could return search results through nodes 102(i), 102(g), and 102(b). Alternatively, node 102(k) could send the results directly to node 102(a).

Filtering of results may be performed in a number of different ways. For example, node 102(a) may simply query all first-degree nodes and then filter the results based on ratings relationships with other nodes or tags associated with the relationships. In this embodiment, nodes may send rating information back with the results where the rating information defines a rating between the node sending the result and that nodes first degree relationship node which either originated the query or propagated the query. Alternatively, if a relationship is rated lower or negatively, or includes tags that are rated lower or negatively, queries may simply not be sent to the other node in the relationship. For example, if the relationship between entities for nodes 102(a) and 102(c) is tagged with music and movie tags, where the music tag is rated high or positively, but the movie tag is rated low or negatively, and the search is directed to movies, a query may simply not be sent from node 102(a) to node 102(c). Alternatively, the query may be sent, but the results may be marked with an indicator indicating that they are less relevant.

Publishing data or search results may be performed in a fashion that allows for ranking of search results. This may allow more relevant data to be displayed more prominently to a user. Factors that can be used in determining relevance rankings may include degrees of relatedness among nodes, ratings of relationships, ratings of tags, and/or other factors. For example, the search result being generated as a result of a first-degree relationship at the node where results are provided to a user may tend to cause the result to be considered as more relevant than if the result were a second, third, or other degree relationship. Additionally and/or alternatively, a relationship that is rated higher or positively, or tags within a relationship being rated higher or positively may cause a result to be considered to be more relevant than if the relationships or tags were rated lower or negatively. Additionally relevance may be based on relationships at the nodes from which results are received. For example, if a node has a large number of first-degree relationships, that node may be considered to be more relevant or to have more trustworthy information. For example, results returned from node 102(a) with 5 first-degree relationships may be considered more relevant or trustworthy than results from node 102(k) which has only one first-degree relationship. Similar rankings may be performed for more distant degree relationships. For example, results sent from a node may include a weight which is assigned based on the number of all relationships, with closer degree relationships contributing more to the weight than more distant degree relationships.

The way a query crawls the social network can performed automatically or manually and may be influenced by evaluation of factors directed to established metrics on the elements of the network. For example, a search may be such that only results of certain relevance or a given number of the most relevant results are returned. Thus, as a query crawls the social network, and once results fall below a given relevance threshold, or once a given number of results have been returned, then a query for the search may be terminated from further propagating. This may be accomplished by sending messages to nodes that return results to no longer propagate any queries for the search. For example, if a node returns a result that is below a threshold relevance, a message may be sent to the node to indicate that the node should not propagate the query. If a node returns a result after the given number of results have been received, then a message may be sent to the node to indicate that the node should not propagate the query further.

Notably, while the searching embodiments described above may be particularly well suited for the distributed social network topology 100 illustrated in FIG. 1, the search techniques may also be implemented in traditional social networks where control over data in the social network is ultimately vested in a central authority for the social network. Specifically, embodiments may be implemented where nodes are implemented on a single server (including a single distributed server) under the control of a central authority.

Embodiments may also be implemented to allow for sharing of advertising revenue. In one embodiment, content that travels on the social network 100 can have embedded advertisement markup. When the advertisement markup causes an advertisement to be displayed, funds can be paid to various entities responsible for causing the advertisement to be displayed. For example, typically an advertiser will pay a certain amount of money for a given number of impressions. Impressions can be calculated, or at least estimated, based on the number of times that an advertisement is displayed. Embodiments may include functionality for compensating entities for facilitating displaying advertisements.

For example, embodiments may allow data to be sent between nodes with the embedded advertisement markup along with information that identifies all entities involved in facilitating the delivery of an advertisement associated with the advertisement markup to a user. For example, information may be included that identifies a content creator with which the advertisement markup is associated along with entities corresponding to nodes that relay the content and the advertisement markup. Each of the entities involved in facilitating the delivery of an advertisement associated with the advertisement markup to a user could then be compensated according to a predetermined scheme. For example, in one embodiment, the content creator may determine in what proportions other entities are compensated. In particular, it is likely that a party paying for impressions will have an agreement with the creator of the content to provide for payment. The creator can then make business decisions on how to compensate other entities to maximize advertising revenues by maximizing the number of impressions delivered. For example, entities with more or higher rated relationships may be compensated more than entities with less or lower rated relationships.

The following discussion now refers to a number of methods and method acts that may be performed. It should be noted, that although the method acts may be discussed in a certain order, no particular ordering is necessarily required unless specifically stated, or required because an act is dependent on another act being completed prior to the act being performed.

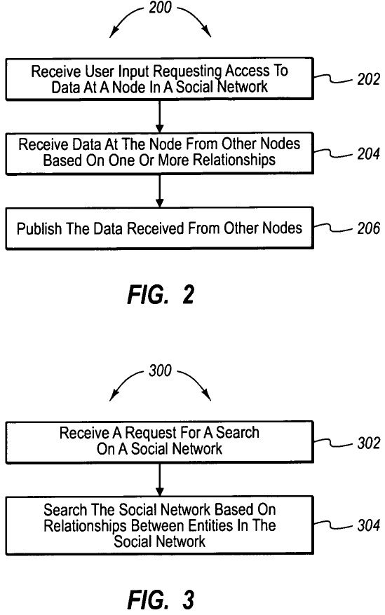

Referring now to FIG. 2, a method 200 is illustrated. The method 200 includes acts for accessing data through a social network. The method includes receiving user input at a node in the social network requesting access to data at a node in the social network (act 202). The node includes data for an entity. The entity controls the data at the node exclusive of centralized control of the social network. Excluding central authority may be defined for example, by no central authority of the social network being able to delete, change, or add data at the node without authority being granted by the entity. The node further includes one or more references defining relationships to other nodes. For example, nodes may have friendship relationships, co-worker relationships, employee-subordinate relationships, etc. The relationships are defined on an informational basis such that information in data at one node is related through a relationship to information in data at another node, wherein each of the other nodes includes other data about other entities. The data at one or more of the other nodes is controlled by each their respective entity exclusive of centralized control of the social network.

The method 200 further includes receiving data at the node from one or more of the other nodes based on one or more of the relationships (act 204). For example, data may be received at node 102(a) from one or more of the nodes 102(b)-102(f). The data may be received as a result of publishing occurring on one of the other nodes. In an alternative embodiment, the data may be received as a result of a query from node 102(a) that propagates out to the other nodes as described previously herein. For example, the method 200 may be performed so as to include receiving user input at the node including search parameters, performing a search based on one or more of the relationships, and returning search results based on relevance, wherein the relevance is determined based on the relationships.

Embodiments of the method 200 may be performed where performing a search based on one or more of the relationships includes using automatic metrics on the social network to channel crawling in the context of a search. For example, searching may be governed by limiting the number of search results or the quality of search results. For example, searching may be performed where only results with a given tag rating are desired, or where only a limited number of the best results should be returned. Searching can be terminated as described above when results fall below of given threshold for ratings or when a given number of results have been returned.

The method 200 further includes, at the node, publishing the data from the other nodes (act 206). For example, the node 102(a) may publish data received from any of the other notes 102(b)-102(f).

The method 200 may be practiced where the node includes rating information associated with one or more of the relationships. For example, a node may rate a relationship with another node positively or negatively, or assign a relative weight to a relationship. Additionally, relationships may be tagged, such as with keywords, where the tags are rated. The tags can be rated positively or negatively, or by a relative weight indicating a level of trust or a level of confidence in data at the other node.

The method 200 may be practiced where receiving data at the node from one or more of the other nodes is performed as a result of user interaction with node. For example, user interaction with node 102(a) may cause a transfer of data from node 102(b).

In an alternative embodiment, the method 200 may be practiced where receiving data at the node from one or more of the other nodes is performed automatically without user interaction. For example, receiving data may be performed as a result of preference settings at the node. In another example, receiving data at the node from one or more of the other nodes automatically is performed based on rating of relationships between nodes. In yet another embodiment, receiving data at the node from one or more of the other nodes automatically is performed based on rating tags of the relationships.

Embodiments of the method 200 may be practiced where receiving data at the node from one or more of the other nodes based on one or more of the relationships includes receiving advertisement data. In this embodiment, the method 200 may further include sending information about the node, such that the information about the node may be used with information used where nodes that displayed or relayed the advertisement data are provided with a share of ad revenue. For example, node 102(a) may receive advertising data from node 102(b). If node 102(a) chooses to display the advertising data, such as by displaying an advertisement specified in advertisement markup, information identifying node 102(a) may be sent to node 102(b). This information can be used to compensate the entity corresponding to node 102(a) for displaying the advertising data. Additionally, if the advertising data is sent to node 102(a) from node 102(k) through node 102(i), through node 102(h) and node 102(b), information may be relayed to node 102(i) indicating that the information was forwarded by nodes 102(i), 102(h) and 102(b) such that entities corresponding to those nodes can be compensated as well.

Referring now to FIG. 3, a method 300 is illustrated. The method includes acts for searching for data through a social network. The method 300 includes receiving user input at a node in the social network requesting a search for data on the social network (act 302). The node includes data for an entity. The node further includes one or more references defining relationships to one or more other nodes. The relationships are defined on an informational basis such that information in data at one node is related through the relationship to information in data at another node. Each of the other nodes includes other data about other entities corresponding to the other nodes.

The method 200 further includes searching for the data based on the relationships. For example, entities may have friendship, co-worker, supervisor/subordinate or other relationships. Nodes can be linked through these relationships such that information at the nodes is linked through the relationships. Searching can be performed based on these relationships. Searching may proceed, for example, first to nodes with first degree relationships and then to subsequent degree relationships.

The method 300 may further include receiving results from other nodes the results being classified based on degrees of relationships; and presenting the results to a user in a format based on the degrees of relationships. Results from first degree relationships may be considered to be more relevant than results from subsequent degree relationships. Thus, it may be advantageous to display results from first degree relationships more prominently than results from subsequent degree relationships. For example, if node 102(a) receives search results from node 102(b) and node 102(g), the results from node 102(b) may be displayed more prominently than results from 102(g).

The method 300 may include receiving results from other nodes where the results are classified based on ratings of nodes in the social network. The results are presented to a user in a format based on the ratings. For example, node may rate a relationship to another node. Relationships to nodes that are rated higher may cause results from those nodes displayed more prominently than relationships to nodes that are rated lower.

The method 300 may further include receiving results from other nodes where the results are classified based on metrics. The results are presented to a user in a format based on the metrics. In one embodiment, the metrics includes, for a given results, the result being sourced from a given node, an indication of a number of nodes that have a friend relationship to the given node.

Embodiments herein may comprise a special purpose or general-purpose computer including various computer hardware, as discussed in greater detail below.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of accessing data through a social network, the method comprising:
receiving user input at a node in a social network requesting access to data, wherein the node comprises data for an entity, and wherein the entity controls the data at the node exclusive of centralized control of the social network, wherein the node further comprises one or more references defining relationships to other nodes, wherein the relationships are defined on an informational basis such that information in data at one node is related through a relationship to information in data at another node, wherein each of the other nodes includes other data about other entities, wherein the data at one or more of the other nodes is controlled by each their respective entity exclusive of centralized control of the social network;
receiving data at the node from one or more of the other nodes based on one or more of the relationships; and
at the node, publishing the data from the other nodes.

2. The method of claim 1, wherein the node comprises rating information associated with one or more of the relationships.

3. The method of claim 1, wherein receiving data at the node from one or more of the other nodes is performed as a result of user interaction with node.

4. The method of claim 1, wherein receiving data at the node from one or more of the other nodes is performed automatically without user interaction.

5. The method of claim 4, wherein receiving data at the node from one or more of the other nodes automatically is performed as a result of preference settings at the node.

6. The method of claim 4, wherein receiving data at the node from one or more of the other nodes automatically is performed based on rating of relationships between nodes.

7. The method of claim 4, wherein receiving data at the node from one or more of the other nodes automatically is performed based on ratings of tags of the relationships.

8. The method of claim 1, further comprising;
receiving user input at the node including search parameters;
performing a search based on one or more of the relationships; and
returning search results based on relevance, wherein the relevance is determined based on the relationships.

9. The method of claim 8, wherein performing a search based on one or more of the relationships comprises using automatic metrics on the social network to channel crawling in the context of a search.

10. The method of claim 8, wherein the relevance is further determined based on relationships at the other nodes to still other nodes.

11. The method of claim 1, wherein receiving data at the node from one or more of the other nodes based on one or more of the relationships comprises receiving advertisement data, the method further comprising:
sending information about the node, such that the information about the node is provided to such that nodes that displayed or relayed the advertisement data are provided with a share of ad revenue

12. A method of search for data through a social network, the method comprising:
receiving user input at a node in a social network requesting a search for data on the social network, wherein the node comprises data for an entity, wherein the node further comprises one or more references defining relationships to one or more other nodes, wherein the relationships are defined on an informational basis such that information in data at one node is related through the relationship to information in data at another node, wherein each of the other nodes includes other data about other entities; and
searching for the data based on the relationships.

13. The method of claim 12, further comprising:
receiving results from other nodes, the results being classified based on degrees of relationships; and
presenting the results to a user in a format based on the degrees of relationships.

14. The method of claim 12, further comprising:
receiving results from other nodes, the results being classified based on ratings of nodes in the social network; and
presenting the results to a user in a format based on the ratings.

15. The method of claim 12, further comprising:
receiving results from other nodes, the results being classified based on metrics; and
presenting the results to a user in a format based on the metrics.

16. The method of claim 15, wherein the metrics comprises, for a given results, the result being sourced from a given node, an indication of a number of nodes where the corresponding entities have a relationship with the given node.

17. The method of claim 12, wherein at least some of the nodes comprises data controlled by the entities for the nodes exclusive of centralized control of the data for the nodes.

18. The method of claim 17, wherein at least some of the nodes are implemented on each their own separate server.

19. In a computing environment, a method of implementing a social network, the method comprising:
at a first node in a social network establishing first degree relationships with one or more other nodes, wherein the first node comprises data for an entity, and wherein the entity controls the data at the first node exclusive of centralized control of the social network, wherein the relationships are defined on an informational basis such that information in data at one node is related through a relationship to information in data at another node, wherein each of the other nodes includes other data about other entities, wherein the data at one or more of the other nodes is controlled by each their respective entity exclusive of centralized control of the social network;
at the first node, establishing rating information for each of the first degree relationships, wherein the rating information defines a degree of trust for a given first degree relationship;
searching for data based on the first degree relationships by sending a query to at least some of the other nodes with a first degree relationship to the first node;
receiving data at the node from the at least some of the other nodes based on the query and based on the first degree relationship to the first node;
at the first node, publishing the data received from the at least some of the other nodes.

20. The method of claim 19, further comprising receiving data at the node from still other nodes based on relationships other than a first degree relationship as a result of one or more of the other nodes with a first degree relationship to the node sending the query to the still other nodes.
